(19) United States
(12) Patent Application Publication
(10) Pub. No.: US 2013/0019866 A1
(43) Pub. Date: Jan. 24, 2013

(54) LAVATORY CHEMICAL OXYGEN WITH REMOTELY LOCATED OXYGEN GENERATION

(71) Applicants: NICOLAS BEHR, KIRKLAND, WA (US); CHARLES FORSTER, ARLINGTON, WA (US); FRED OPP, CAMANO ISLAND, WA (US); TREVOR SKELLY, MERCER ISLAND, WA (US); TIM PAHLS, LAKE STEVENS, WA (US); TIM HUGHES, SNOHOMISH, WA (US)

(72) Inventors: NICOLAS BEHR, KIRKLAND, WA (US); CHARLES FORSTER, ARLINGTON, WA (US); FRED OPP, CAMANO ISLAND, WA (US); TREVOR SKELLY, MERCER ISLAND, WA (US); TIM PAHLS, LAKE STEVENS, WA (US); TIM HUGHES, SNOHOMISH, WA (US)

(73) Assignee: BE INTELLECTUAL PROPERTY, INC., WELLINGTON, FL (US)

(21) Appl. No.: 13/533,558

(22) Filed: Jun. 26, 2012

Related U.S. Application Data
(60) Provisional application No. 61/509,556, filed on Jul. 19, 2011.

(51) Int. Cl. A62B 7/08; A62B 18/02

(52) U.S. Cl. 128/202.26

(57) ABSTRACT

A lavatory chemical oxygen system for providing breathing gas to an aircraft lavatory includes a remotely located oxygen generation system for supplying oxygen to the aircraft lavatory. The lavatory chemical oxygen system includes an aircraft passenger main cabin, an aircraft lavatory, and a lavatory oxygen drop box housing with a lavatory oxygen mask in the aircraft lavatory. A chemical oxygen generator located remotely from the aircraft lavatory is connected to the lavatory oxygen mask to provide supplemental oxygen to an occupant of the lavatory. The chemical oxygen generator can be activated electronically or manually.

### CROSS-REFERENCES TO RELATED APPLICATIONS

This application is based upon and claims priority from U.S. Application No. 61/509,556, filed Jul. 19, 2011, incorporated by reference in its entirety.

### BACKGROUND OF THE INVENTION

The present invention relates generally to chemical oxygen generators for aircraft, and more particularly relates to installation and operation of an aircraft chemical oxygen generator remotely from an aircraft lavatory to which the aircraft chemical oxygen generator is configured to supply oxygen.

Passenger aircraft have typically provided passenger cabin areas as well as passenger lavatories with an oxygen supply with emergency oxygen masks that drop down to provide oxygen to passengers in the event of decompression of the aircraft at high altitudes. One conventional system for supplying oxygen to an aircraft cabin is known that includes a plurality of chemical oxygen generators with igniters and sequencers for energizing the igniters in sequence, and oxygen masks to which the chemical generators distribute the oxygen generated. A pressure sensor in part of the distribution system controls the sequencers to energize the igniter of the next chemical generator in sequence whenever the pressure drops below a threshold. Another conventional system for supplying emergency oxygen for passengers in aircraft is known that includes a mounting container that accommodates at least one breathing mask and an exothermic chemical oxygen generator connected to the breathing mask. Pivotability of the lid of the mounting container is improved to permit the oxygen generator to change its place by pivoting.

However, for certain passenger-carrying transport category airplanes with a passenger capacity of 20 or more, the Federal Aviation Authority (FAA) recently required either activating all chemical oxygen generators in the lavatories of the aircraft until the generator oxygen supply is expended, or removing the oxygen generators, and removing or re-stowing the oxygen masks and closing the mask dispenser door in the lavatories after the generator is expended or removed, to eliminate a potential hazard from placement of the chemical oxygen generators in the aircraft lavatories. Flight attendants are currently being instructed to check if lavatories are occupied in when a cabin depressurization occurs, to attempt to provide assistance to any occupants of the lavatories in quickly obtaining emergency oxygen. However, locking of lavatory doors by lavatory occupants and collapsing of lavatory occupants during such a cabin depressurization incident can potentially at least interfere with the rendering of assistance in obtaining emergency oxygen to lavatory occupants by flight attendants. It would therefore be desirable to provide a lavatory oxygen system to provide an aircraft chemical oxygen generator located and operated remotely from an aircraft lavatory to which the aircraft chemical oxygen generator supplies oxygen. The present invention meets these and other needs.

### SUMMARY OF THE INVENTION

Briefly and in general terms, the present invention provides for a system for supplying oxygen to an aircraft lavatory by installing and operating an aircraft chemical oxygen generator remotely from the aircraft lavatory to which the aircraft chemical oxygen generator supplies oxygen.

The present invention accordingly provides for a system for supplying supplemental oxygen to an aircraft lavatory of an aircraft passenger main cabin. The system includes an aircraft passenger main cabin including an aircraft lavatory, a lavatory oxygen drop box housing disposed in the aircraft lavatory and including a lavatory oxygen mask configured to provide supplemental oxygen to an occupant of the aircraft lavatory, and a chemical oxygen generator connected to the lavatory oxygen mask to provide supplemental oxygen to the lavatory oxygen mask. The chemical oxygen generator is advantageously disposed remotely from the aircraft lavatory and oxygen drop box housing in an area of the aircraft substantially spaced apart from the aircraft lavatory and oxygen drop box housing, typically via a low pressure tubing connected between the chemical oxygen generator and the lavatory oxygen mask.

A main cabin decompression relay is configured to transmit an oxygen generation signal in the event of a depressurization or decompression event within the aircraft passenger main cabin. During a decompression event, a pressure switch located within the airplane automatically energizes a main cabin decompression relay, which then sends a signal to all oxygen drop boxes throughout the main cabin. This signal energizes a solenoid latch which opens the oxygen box door and presents masks to the occupants. When a mask is pulled, a pintle is released from the chemical oxygen generator and oxygen begins to flow freely to the mask. In a presently preferred aspect, the main cabin decompression relay is also disposed in an area of the aircraft substantially spaced apart from and remote from the aircraft lavatory and oxygen drop box housing. Using the same signal from the main cabin decompression relay, a chemical oxygen generation initiation device is connected to the chemical oxygen generator, and is configured to initiate generation of oxygen by the chemical oxygen generator to supply supplemental oxygen to the oxygen mask in the lavatory oxygen drop box housing. The chemical oxygen generation initiation device is electrically connected to the main cabin decompression relay to receive the oxygen generation signal from the main cabin decompression relay in the event of a depressurization or decompression event within the aircraft passenger main cabin.

In a presently preferred variation, the chemical oxygen generation initiation device preferably can alternatively additionally be manually activated, such as by a cable having a first end operatively connected to the chemical oxygen generation initiation device to trigger the chemical oxygen generation initiation device when an opposing second end of the cable is pulled or otherwise operated manually. In a presently preferred aspect, the second end of the cable is accessible from the lavatory oxygen drop box housing, and preferably is disposed within the lavatory oxygen drop box housing, so that when the lavatory oxygen drop box housing opens the second end of the cable becomes accessible, and can be pulled or otherwise operated manually to activate the chemical oxygen generation initiation device, to initiate generation of oxygen by the chemical oxygen generator to supply supplemental oxygen through the low pressure tubing to the oxygen mask in the lavatory oxygen drop box housing.

Other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a schematic diagram of the system for supplying supplemental oxygen to an aircraft lavatory, according to the present invention.

FIG. 2 is a schematic diagram of a variation of the system for supplying supplemental oxygen to an aircraft lavatory, according to the present invention.

### DETAILED DESCRIPTION OF THE PREFERRED EMBODIMENTS

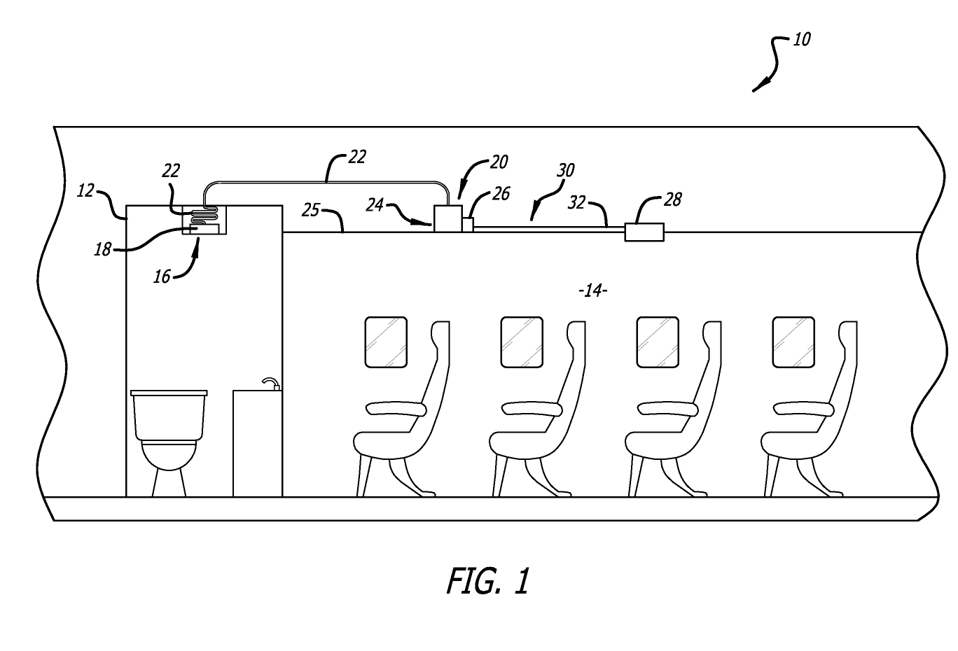

Referring to the drawings, which are provided by way of example, and not by way of limitation, the present invention provides for an aircraft lavatory supplemental oxygen supply system 10 for supplying oxygen to an aircraft lavatory 12 of an aircraft passenger main cabin 14, as is illustrated in FIG. 1. The aircraft lavatory supplemental oxygen supply system includes a lavatory oxygen drop box housing 16 disposed in the aircraft lavatory and containing a lavatory oxygen mask 18 configured to provide supplemental oxygen to an occupant of the aircraft lavatory.

The lavatory oxygen mask is connected to receive supplemental oxygen from a chemical oxygen generator 20 via a low pressure tubing 22 connected between the chemical oxygen generator and the lavatory oxygen mask. The chemical oxygen generator is advantageously disposed remotely from the aircraft lavatory and oxygen drop box housing in an area 24 of the aircraft substantially spaced apart from the aircraft lavatory and oxygen drop box housing, and is typically placed above a ceiling 25 so as to be substantially inaccessible to passengers.

A chemical oxygen generation initiation device 26 is connected to the chemical oxygen generator configured to initiate generation of oxygen by the chemical oxygen generator to supply supplemental oxygen through the low pressure tubing to the oxygen mask in the lavatory oxygen drop box housing. The chemical oxygen generation initiation device is electrically connected to a main cabin decompression relay 28 to receive an electrical oxygen generation signal 30 from the main cabin decompression relay via an electrical connection 32 between the main cabin decompression relay and the chemical oxygen generation initiation device in the event of a depressurization or decompression event within the aircraft passenger main cabin.

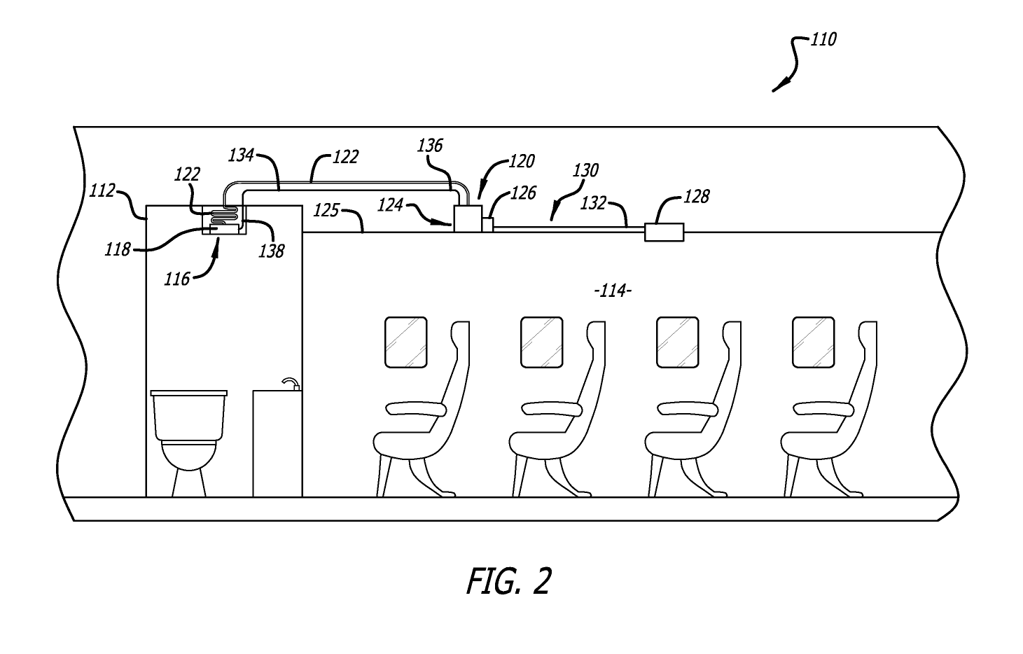

Referring to the FIG. 2, in a variation of the invention described above and illustrated in FIG. 1, the present invention provides for an aircraft lavatory supplemental oxygen supply system 110 for supplying oxygen to an aircraft lavatory 112 of an aircraft passenger main cabin 114. The aircraft lavatory supplemental oxygen supply system includes a lavatory oxygen drop box housing 116 disposed in the aircraft lavatory and containing a lavatory oxygen mask 118 configured to provide supplemental oxygen to an occupant of the aircraft lavatory.

The lavatory oxygen mask is connected to receive supplemental oxygen from a chemical oxygen generator 120 via a low pressure tubing 122 connected between the chemical oxygen generator and the lavatory oxygen mask. The chemical oxygen generator is advantageously disposed remotely from the aircraft lavatory and oxygen drop box housing in an area 124 of the aircraft substantially spaced apart from the aircraft lavatory and oxygen drop box housing, and is typically placed above a ceiling 125 so as to be substantially inaccessible to passengers.

A chemical oxygen generation initiation device 126 is connected to the chemical oxygen generator configured to initiate generation of oxygen by the chemical oxygen generator to supply supplemental oxygen through the low pressure tubing to the oxygen mask in the lavatory oxygen drop box housing. The chemical oxygen generation initiation device is electrically connected to a main cabin decompression relay 128 to receive an electrical oxygen generation signal 130 from the main cabin decompression relay via an electrical connection 132 between the main cabin decompression relay and the chemical oxygen generation initiation device in the event of a depressurization or decompression event within the aircraft passenger main cabin.

As is illustrated in FIG. 2, the chemical oxygen generation initiation device preferably can alternatively additionally be manually activated, such as by a cable 134 having a first end 136 operatively connected to the chemical oxygen generation initiation device to trigger the chemical oxygen generation initiation device when an opposing second end 138 of the cable is pulled manually. In a presently preferred aspect, the second end of the cable is accessible from the lavatory oxygen drop box housing, and preferably is disposed within the lavatory oxygen drop box housing, so that when the lavatory oxygen drop box housing opens the second end of the cable becomes accessible and can be pulled or otherwise operated manually to activate the chemical oxygen generation initiation device, to initiate generation of oxygen by the chemical oxygen generator to supply supplemental oxygen through the low pressure tubing to the oxygen mask in the lavatory oxygen drop box housing.

It will be apparent from the foregoing that while particular forms of the invention have been illustrated and described, various modifications can be made without departing from the spirit and scope of the invention.

What is claimed is:

1. A system for supplying supplemental oxygen to an aircraft lavatory of an aircraft passenger main cabin, the system comprising:
an aircraft passenger main cabin including an aircraft lavatory;
a lavatory oxygen drop box housing disposed in the aircraft lavatory, the lavatory oxygen drop box housing including a lavatory oxygen mask configured to provide supplemental oxygen to an occupant of the aircraft lavatory;
a main cabin decompression relay configured to transmit an oxygen generation signal in the event of a depressurization or decompression event within the aircraft passenger main cabin;
a chemical oxygen generator connected to the lavatory oxygen mask to provide supplemental oxygen to the lavatory oxygen mask, the chemical oxygen generator being disposed remotely from the aircraft lavatory and the main cabin decompression relay; and
a chemical oxygen generation initiation device connected to the chemical oxygen generator, said chemical oxygen generation initiation device being electrically connected to the main cabin decompression relay to receive said oxygen generation signal from the main cabin decompression relay in the event of a depressurization or decompression event within the aircraft passenger main cabin, and said chemical oxygen generation initiation device being configured to initiate generation of oxygen by the chemical oxygen generator to supply supplemental oxygen to the oxygen mask in the lavatory oxygen drop box housing when said oxygen generation signal is received from the main cabin decompression relay.

2. The system of claim 1, wherein said chemical oxygen generator is connected in fluid communication with said lavatory oxygen mask by a low pressure tubing.

3. The system of claim 1, wherein said main cabin decompression relay is configured to transmit said oxygen generation signal via an electrical connection between the main cabin decompression relay and the chemical oxygen generation initiation device.

4. The system of claim 1, wherein said chemical oxygen generation initiation device is additionally configured to be operated manually.

5. The system of claim 1, further comprising a cable having a first end and an opposing second end, said first end of said cable being operatively connected to said chemical oxygen generation initiation device to trigger the chemical oxygen generation initiation device when said opposing second end of the cable is pulled manually.

6. The system of claim 5, wherein said opposing second end of said cable is accessible from the lavatory oxygen drop box housing.

7. The system of claim 5, wherein said opposing second end of said cable is disposed within said lavatory oxygen drop box housing, such that when the lavatory oxygen drop box housing opens the second end of the cable is accessible and can be pulled manually to activate said chemical oxygen generation initiation device, to initiate generation of oxygen by the chemical oxygen generator to supply supplemental oxygen through the low pressure tubing to the oxygen mask in the lavatory oxygen drop box housing.

8. A system for supplying supplemental oxygen to an aircraft lavatory of an aircraft passenger main cabin, the system comprising:
an aircraft passenger main cabin including an aircraft lavatory;
a lavatory oxygen drop box housing disposed in the aircraft lavatory, the lavatory oxygen drop box housing including a lavatory oxygen mask configured to provide supplemental oxygen to an occupant of the aircraft lavatory;
a chemical oxygen generator connected to the lavatory oxygen mask to provide supplemental oxygen to the lavatory oxygen mask, the chemical oxygen generator being disposed remotely from the aircraft lavatory and oxygen drop box housing in an area of the aircraft substantially spaced apart from the aircraft lavatory and oxygen drop box housing;
a main cabin decompression relay configured to transmit an oxygen generation signal in the event of a depressurization or decompression event within the aircraft passenger main cabin; and
a chemical oxygen generation initiation device connected to the chemical oxygen generator, said chemical oxygen generation initiation device being electrically connected to the main cabin decompression relay to receive said oxygen generation signal from the main cabin decompression relay in the event of a depressurization or decompression event within the aircraft passenger main cabin, and said chemical oxygen generation initiation device being configured to initiate generation of oxygen by the chemical oxygen generator to supply supplemental oxygen to the oxygen mask in the lavatory oxygen drop box housing when said oxygen generation signal is received from the main cabin decompression relay.

9. The system of claim 8, wherein said chemical oxygen generator is connected in fluid communication with said lavatory oxygen mask by a low pressure tubing.

10. The system of claim 8, wherein said main cabin decompression relay is configured to transmit said oxygen generation signal via an electrical connection between the main cabin decompression relay and the chemical oxygen generation initiation device.

11. The system of claim 8, wherein said chemical oxygen generation initiation device is additionally configured to be operated manually.

12. The system of claim 8, further comprising a cable having a first end and an opposing second end, said first end of said cable being operatively connected to said chemical oxygen generation initiation device to trigger the chemical oxygen generation initiation device when said opposing second end of the cable is pulled manually.

13. The system of claim 12, wherein said opposing second end of said cable is accessible from the lavatory oxygen drop box housing.

14. The system of claim 12, wherein said opposing second end of said cable is disposed within said lavatory oxygen drop box housing, such that when the lavatory oxygen drop box housing opens the second end of the cable is accessible and can be pulled manually to activate said chemical oxygen generation initiation device, to initiate generation of oxygen by the chemical oxygen generator to supply supplemental oxygen through the low pressure tubing to the oxygen mask in the lavatory oxygen drop box housing.
